(19) United States
(12) Patent Application Publication
(10) Pub. No.: US 2016/0072115 A1
(43) Pub. Date: Mar. 10, 2016

(54) SECONDARY BATTERY

(71) Applicant: SAMSUNG SDI CO., LTD., Yongin-si (KR)

(72) Inventors: Kiwoong KIM, Yongin-si (KR); Jaehoon CHOI, Yongin-si (KR); Kyungjae SHIN, Yongin-si (KR)

(21) Appl. No.: 14/841,802

(22) Filed: Sep. 1, 2015

(30) Foreign Application Priority Data
Sep. 4, 2014 (KR) 10-2014-0118020

(51) Int. Cl. H01M 2/26; H01M 2/30; B23K 35/30; B23K 20/22; B23K 35/02; B23K 35/26; H01M 10/42; B23K 20/10

(52) U.S. Cl. CPC H01M 2/26; H01M 10/425; H01M 2/30; B23K 20/10; B23K 20/22; B23K 35/025; B23K 35/262; B23K 35/3006; B23K 35/302; B23K 2203/10

(57) ABSTRACT

A secondary battery includes a bare cell and a protective circuit module. The protective circuit module includes a protective circuit board, a first terminal, and a second terminal. The first and second terminals are electrically connected to positive and negative electrode tabs of the bare cell. The positive electrode tab and the negative electrode tab are respectively soldered to the first terminal and the second terminal, solder layers are on respective surfaces of the positive electrode tab soldered to the first terminal, and a solder layer is on one or more of the second terminal or the negative electrode tab.

### CROSS-REFERENCE TO RELATED APPLICATION

Korean Patent Application No. 10-2014-0118020, filed on Sep. 4, 2014, and entitled, “Secondary Battery,” is incorporated by reference herein in its entirety.

### BACKGROUND

1. Field

One or more embodiments described herein relate to a secondary battery.

2. Description of the Related Art

Secondary batteries are rechargeable and are widely used in mobile devices including but not limited to smartphones, laptop computers, tablet personal computers, personal digital assistants, camcorders, digital cameras. Secondary batteries are also used in larger devices such as electric vehicles, hybrid electric vehicles, electric bicycles, uninterruptible power supplies (UPSs), and energy storage systems (ESSs). To make the use of secondary batteries safe, a protective circuit module (PCM) may be electrically coupled to a bare cell accommodating an electrode assembly.

### SUMMARY

In accordance with one embodiment, a secondary battery includes a bare cell including an electrode assembly, electrode tabs, and a case accommodating the electrode assembly, the electrode assembly including a separator between a positive electrode plate and a negative electrode plate, the electrode tabs including positive and negative electrode tabs respectively extending from the positive and negative electrode plates; and a protective circuit module outside the case and including a protective circuit board, a first terminal, and a second terminal, the first and second terminals on the protective circuit board and electrically connected to the positive and negative electrode tabs, respectively, wherein: the positive electrode tab and the negative electrode tab are respectively soldered to the first terminal and the second terminal, solder layers are on respective surfaces of the positive electrode tab soldered to the first terminal, and a solder layer is on one or more of the second terminal or the negative electrode tab.

The positive electrode tab may include a first surface facing the first terminal and a second surface opposite the first surface, and a first solder layer may be on the first surface and a second solder layer is on the second surface. The positive electrode tab may include a third surface connecting the first and second surfaces, and a third solder layer may be on the third surface. A solder layer may be on a surface of the first terminal facing the first surface of the positive electrode tab. The solder layers may be held on the positive electrode tab by ultrasonic solder.

The negative electrode tab may include a first surface facing the second terminal and a second surface opposite the first surface, and the solder layer may be on one or more of the first surface of the negative electrode tab or a surface of the second terminal facing the first surface of the negative electrode tab. The solder layer may be on only the surface of the second terminal. At least a surface portion of the positive electrode tab may exclude an oxide layer.

In accordance with one embodiment, a method for forming a secondary battery includes applying a solder layer to a first electrode tab of the battery: aligning the first electrode tab and a second electrode tab of the battery with respective first and second terminals; and applying heat to solder the first and second electrode tabs to the first and second terminals, respectively, wherein the first electrode tab includes a first metal and the second electrode tab includes a second metal different from the first metal, and wherein the second electrode tab excludes a solder layer before heat when the first and second electrode tabs are aligned with the first and second terminals.

The first electrode tab may be a positive electrode tab, and the second electrode tab may be a negative electrode tab. The first electrode tab may include aluminum, and the second electrode table may include nickel. The method may include applying a solder layer to the second terminal before the heat is applied.

Applying the solder layer to the first electrode tab may include bending the second electrode tab from a first position to a second position; exposing the first electrode tab to an ultrasonic bath without exposing the second electrode tab to the ultrasonic bath, exposure to the ultrasonic bath forming the solder layer on the first electrode tab; and bending the second electrode tab from the second position to the first position. The first electrode tab may be in the first position when exposed to the ultrasonic bath.

Applying heat may include applying heat to solder the first and second electrode tabs to the first and second terminals, respectively, at substantially a same time. Applying heat may include applying heat to the first electrode tab and an electrode tab of a first different battery at substantially a same time, and applying heat to the second electrode tab an electrode tab of a second different battery at substantially a same time. The heat may be applied to the first electrode tab and the electrode tab of the first different battery at a first time, the heat may be applied to the second electrode tab and the electrode table of the second different battery at a second time, and the first time may be different from the second time. The first electrode tab may exclude a surface oxide layer.

In accordance with another embodiment, an electrode tab arrangement for a secondary battery includes a first electrode tab; a second electrode tab; a first terminal attached to the first electrode tab; and a second terminal attached to the second electrode tab, wherein the first electrode tab includes a solder layer at a first time when the first terminal is soldered to the first electrode tab, and wherein the second electrode tab excludes a solder layer at a second time when the second terminal is soldered to the second electrode tab. The first time may be equal to the second time.

### BRIEF DESCRIPTION OF THE DRAWINGS

Features will become apparent to those of skill in the art by describing in detail exemplary embodiments with reference to the attached drawings in which:

FIG. 1 illustrates an embodiment of a polymer bare cell;

FIG. 2 illustrates an embodiment of a secondary battery;

FIG. 3 illustrates an example of a solder layer on a positive electrode tab;

FIG. 4A illustrates a positive electrode tab, and FIG. 4B illustrates the positive electrode tab after removal of an oxidation layer;

FIG. 5A illustrates the secondary battery in an ultrasonic bath, FIG. 5B illustrates the secondary battery when a negative electrode tab is bent, FIG. 5C illustrates the secondary battery when put in the ultrasonic bath, and FIG. 5D illustrates the secondary battery when the negative electrode tab is bent again according to one embodiment;

FIG. 6A illustrates an embodiment of a circuit board before formation of solder layers on terminals of the circuit board, and FIG. 6B illustrates a plan view illustrating the circuit board after formation of the solder layers according to one embodiment;

FIG. 7A illustrates electrode tabs of the secondary battery aligned with terminals of the circuit board, and FIG. 7B illustrates the electrode tabs soldered to terminals of the circuit board according to one embodiment;

FIG. 8A illustrates electrode tabs of secondary batteries aligned with terminals of circuit boards, and FIG. 8B illustrates the electrode tabs of the secondary batteries soldered to terminals of circuit boards according to another embodiment; and

FIG. 9 illustrates an embodiment of a method for forming a secondary battery.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. In the drawings, the dimensions of layers and regions may be exaggerated for clarity of illustration. Like reference numerals refer to like elements throughout.

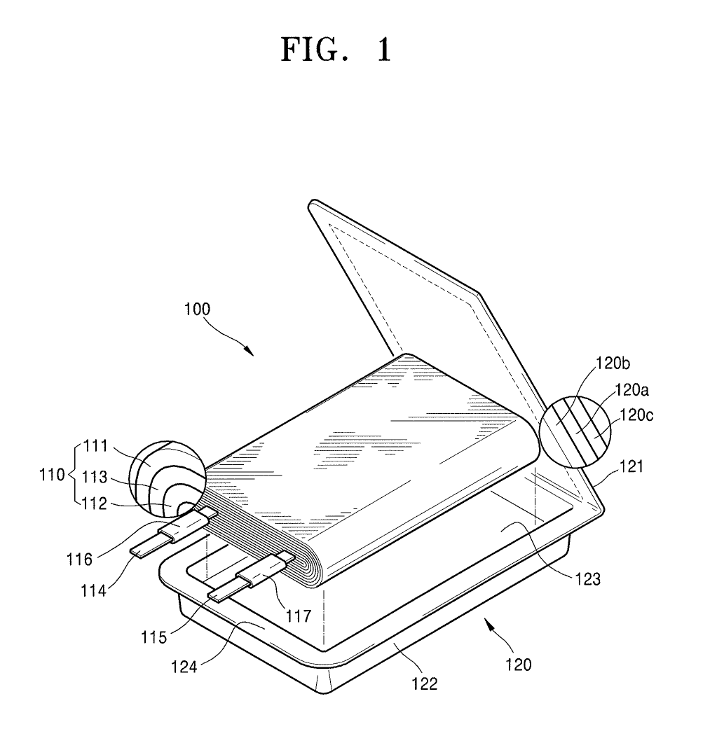

FIG. 1 illustrates an embodiment of a polymer bare cell 100 which includes a case 120 accommodating an electrode assembly 110. The electrode assembly 110 includes a separator 113 between a positive electrode plate 111 and a negative electrode plate 112. A positive electrode tab 114 is electrically connected to the positive electrode plate 111. Positive electrode insulation tape 116 is wound around the positive electrode tab 114. A negative electrode tab 115 is electrically connected to the negative electrode plate 112. Negative electrode insulation tape 117 is wound around the negative electrode tab 115.

The case 120 is a pouched case having flexibility. The case 120 includes an a lower case 122 coupled to an upper case 121. At least one side of the upper case 121 may be formed in one piece with at least one side of the lower case 122. The case 120 may have a three-layer structure formed by metal foil 120a and insulation films 120b and 120c attached to both sides of the metal foil 120a. The case 120 may have a different structure in other embodiments.

The electrode assembly 110 may be disposed in a space 123 in the case 120. The positive electrode insulation tape 116 and the negative electrode insulation tape 117 may be fused together with a sealing surface 124 of the case 120. An end portion of the positive electrode tab 114 and an end portion of the negative electrode tab 115 may be exposed to the outside after the case 120 is sealed.

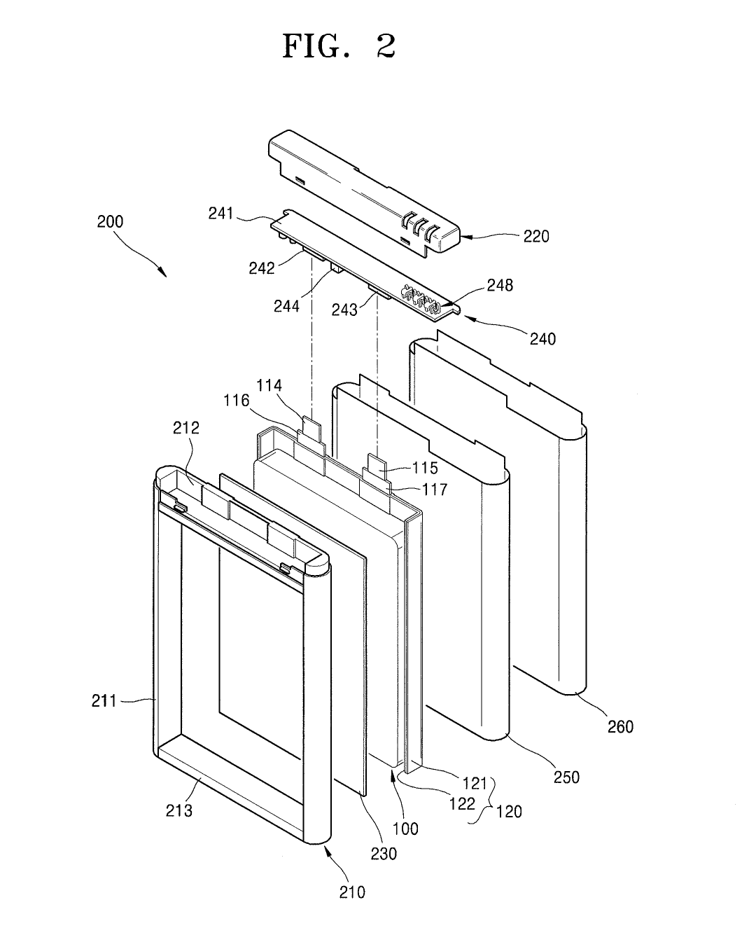

FIG. 2 illustrates an embodiment of a secondary battery 200 which includes a polymer bare cell 100, an outer frame 210, and a top case 220. The polymer bare cell 100 includes a case 120 accommodating an electrode assembly 110 (refer to FIG. 1). An end portion of a positive electrode tab 114 and an end portion of a negative electrode tab 115 may be exposed outside of the case 120 through a short side of the case 120. The end portion of the positive electrode tab 114 and the end portion of the negative electrode tab 115 may extend in a direction toward the top case 220. Since the case 120 is a pouched case having flexibility, the case 120 may be freely folded after the electrode assembly 110 is disposed in the case 120.

A least a portion of the polymer bare cell 100 is covered with the outer frame 210. For example, the outer frame 210 includes first parts 211 covering respective lateral surfaces of long sides of the polymer bare cell 100, a second part 212 covering an upper end of the polymer bare cell 100 from which the positive electrode tab 114 and the negative electrode tab 115 extend, and a third part 213 covering a lower end of the polymer bare cell 100 opposite to the upper end from which the positive electrode tab 114 and the negative electrode tab 115 extend.

In one embodiment, the first parts 211, the second part 212, and the third part 213 may be formed in one piece. The outer frame 210 may be formed, for example, by an injection molding method using polymer resin so as to cover outer surfaces of the polymer bare cell 100.

A label 230 may be disposed between the outer frame 210 and the outer surfaces of the polymer bare cell 100. The label 230 may be attached to a front or rear side of the polymer bare cell 100 using, for example, double-sided tape or an adhesive solution. The label 230 may be attached to the outside of the polymer bare cell 100, for example, before the outer frame 210 is injection-molded with respect to the polymer bare cell 100. The label 230 is attached to the polymer bare cell 100 for providing information about the polymer bare cell 100.

A protective circuit module 240 is disposed between the polymer bare cell 100 and the top case 220. The protective circuit module 240 includes a circuit board 241. First and second terminals 242 and 243 and a plurality of electronic devices 244 are disposed on the circuit board 241.

The circuit board 241 may be a printed circuit board (PCB) on which at least one circuit pattern is formed. The first terminal 242 may be electrically connected to the positive electrode tab 114. The second terminal 243 may be electrically connected to the negative electrode tab 115. The electronic devices 244 include a positive temperature coefficient (PTC) device, an integrated circuit (IC) chip, a field effect transistor (FET), a resistor, a capacitor, etc. The first terminal 242 and the second terminal 243 may be selectively connected to the electronic devices 244.

The protective circuit module 240 may be accommodated in the top case 220. After the protective circuit module 240 is accommodated in the top case 220, the top case 220 may be coupled to the upper end of the polymer bare cell 100. The top case 220 may protect the protective circuit module 240 from impact forces and prevent a short circuit of the protective circuit module 240. The top case 220 may be a part formed of polymer resin such as polycarbonate. The polymer bare cell 100, partially covered with the outer frame 210, may be disposed in a protective and reinforcing outer case 250. The outer case 250 may be a pouch to which an adhesive is applied. The outer case 250 may be further surrounded by a protective film cover 260.

In the secondary battery 200 having the above-described structure, the first terminal 242 and the second terminal 243 may be electrically connected to the positive electrode tab 114 and the negative electrode tab 115, respectively, by a soldering method.

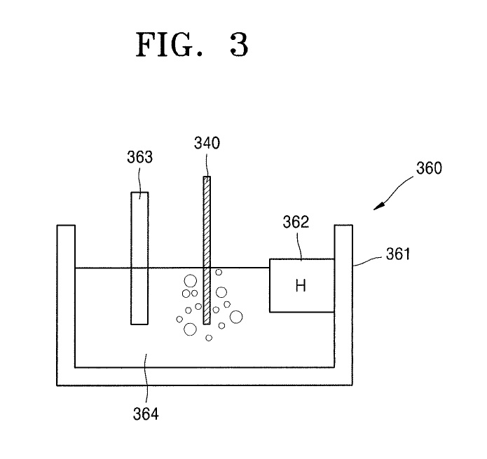

FIG. 3 illustrates an embodiment of a method for forming a solder layer on a positive electrode tab 340 of a secondary battery 300. Referring to FIG. 3, an ultrasonic soldering system 360 includes an ultrasonic bath 361. An ultrasonic horn 362 may be disposed on a side of the ultrasonic bath 361 to generate ultrasonic waves. A solder solution 364 is filled in the ultrasonic bath 361 for performing a soldering process on an electrode tab, such as the positive electrode tab 340. The solder solution 364 may be, for example, a lead (Pb)-free solder solution containing main components such as tin (Sn), silver (Ag), and copper (Cu).

A reflector 363 may be disposed in the ultrasonic bath 361 at a position away from the positive electrode tab 340. The reflector 363 reflects ultrasonic waves generated from the ultrasonic horn 362 to the positive electrode tab 340.

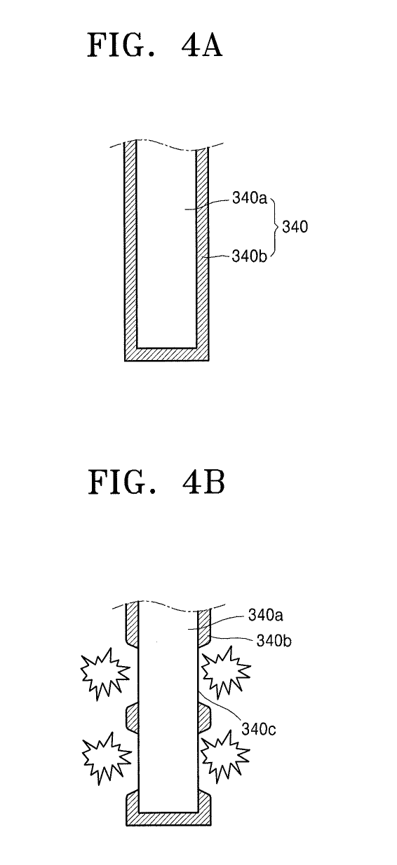

As illustrated in FIG. 4A, a thin oxide layer 340b may be formed on a positive electrode tab plate 340a of the positive electrode tab 340. In an ultrasonic soldering method, the positive electrode tab 340 is eroded by cavitation caused by physical vibration energy of high-frequency waves. For example, the oxide layer 340b may be removed from the positive electrode tab plate 340a as in FIG. 4B. Then a soldering process may be performed on an exposed surface 340c. In one embodiment, the thin oxide layer 340b may be totally removed.

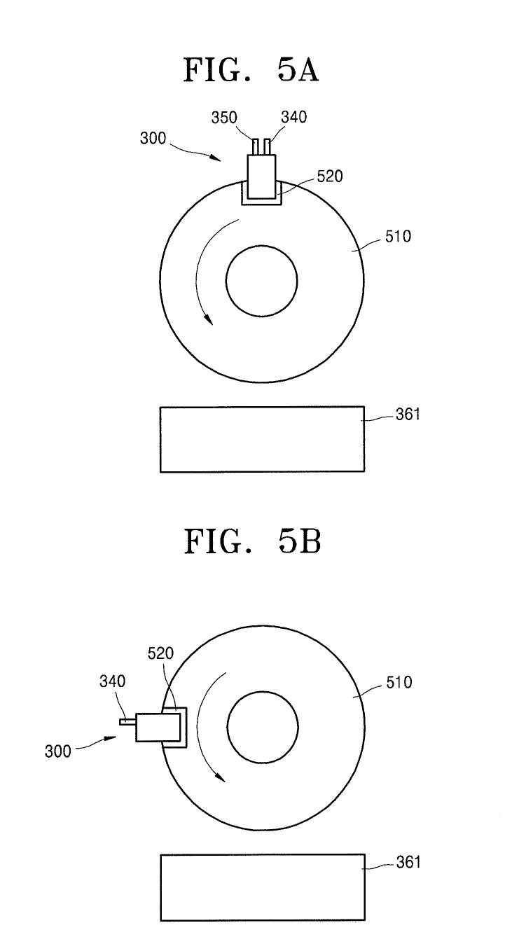

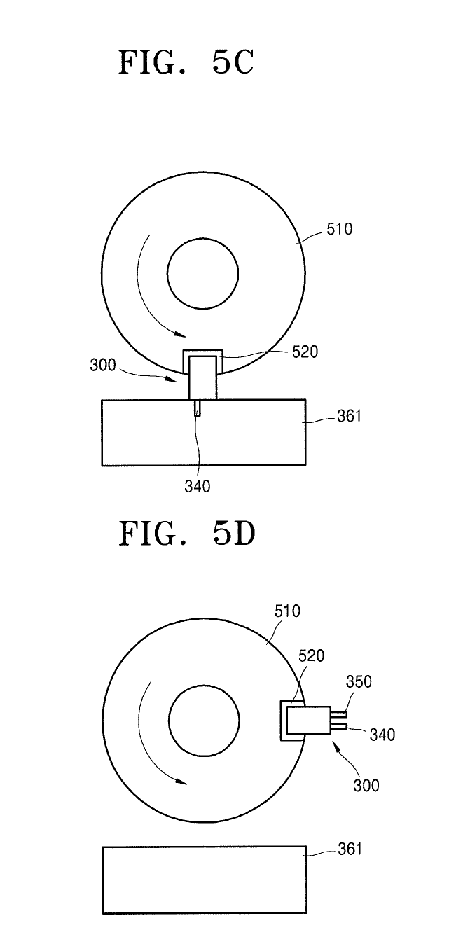

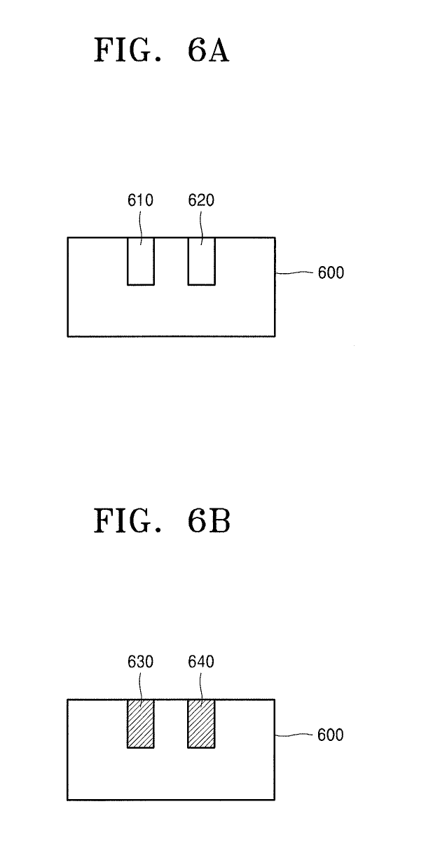

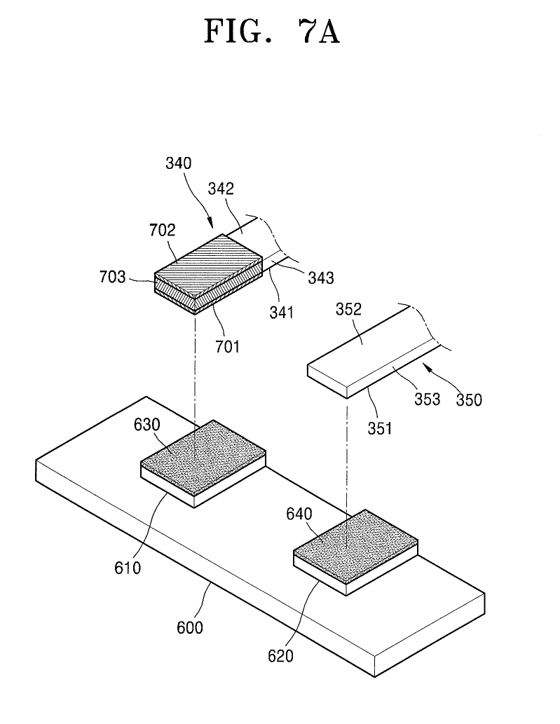

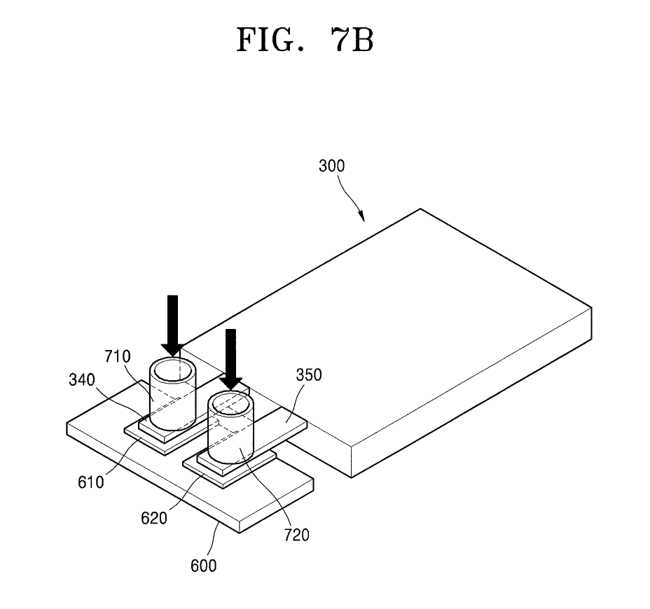

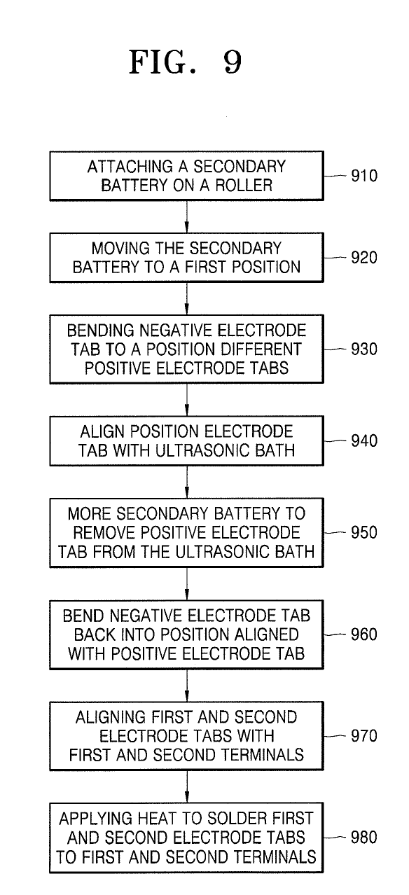

FIG. 5A illustrates the secondary battery 300 of FIG. 3 before the secondary battery 300 is put in the ultrasonic bath 361, FIG. 5B illustrates the secondary battery 300 of FIG. 5A when a negative electrode tab 350 of the secondary battery 300 is bent, FIG. 5C illustrates the secondary battery 300 of FIG. 5B when the secondary battery 300 is put in the ultrasonic bath 361 to form a solder layer on the positive electrode tab 340, FIG. 5D illustrates the secondary battery 300 of FIG. 5C when the negative electrode tab 350 of the secondary battery 300 is bent back into place according to one embodiment. FIG. 9 illustrates operations included in one embodiment of a method for forming one or more solder layers on the positive electrode tab 340, which operations may illustrative correspond to those in FIGS. 5A to 5D, 7A, and 7B.

Referring to FIGS. 5A to 5C, the secondary battery 300 may be mounted on a mount unit and then may be inserted into the ultrasonic bath 361. The mount unit may include, for example, a roller 510 rotatable in one direction.

The secondary battery 300 is mounted on the roller 510 using a jig 520 and is then inserted into the ultrasonic bath 361. A solder layer is formed on the positive electrode tab 340 while the roller 510 is rotated in one direction. However, no solder layer is formed on the negative electrode tab 350.

A solder layer may be formed on only the positive electrode tab 340 due to the following reason. The positive electrode tab 340 includes an aluminum material. Thus, the positive electrode tab 340 has a high degree of ionization tendency due to its material characteristics. Thus, when a soldering process is performed after placing solder between the positive electrode tab 340 and the first terminal 242 of the circuit board 241 (refer to FIG. 2), the solder may not be easily applied to the positive electrode tab 340. Therefore, soldering between the first terminal 242 and the positive electrode tab 340 may not be securely performed.

On the other hand, the negative electrode tab 350 includes a nickel material. The negative electrode tab 350 is easily soldered to the second terminal 243 of the circuit board 241 (refer to FIG. 2).

Thus, before the positive and negative electrode tabs 340 and 350 are soldered to the first and second terminals 242 and 243 of the circuit board 241, a solder layer is formed on only the positive electrode tab 340 using ultrasonic vibration.

For example, referring to FIG. 7A, the positive electrode tab 340 and the negative electrode tab 350 may be electrically connected to a first terminal 610 and a second terminal 620 of a circuit board 600 by soldering.

In one embodiment, first to third solder layers 701 to 703 may be formed on the positive electrode tab 340 to be soldered to the first terminal 610. The positive electrode tab 340 includes a first surface 341 which is a bottom plane facing the first terminal 610 and a second surface 342 which is a top plane opposite the first surface 341. The first surface 341 and the second surface 342 are connected to each other through third surfaces 343 which are lateral planes.

The first solder layer 701 may be formed on the first surface 341, and the second solder layer 702 may be formed on the second surface 342. The third solder layers 703 may be formed on the third surfaces 343. Thus, solder layers are previously formed on the positive electrode tab 340 using the ultrasonic soldering system 360 in FIG. 3.

For example, the positive electrode tab 340 is dipped into the ultrasonic bath 361 (refer to FIG. 3) to form the first to third solder layers 701 to 703 on the outer surfaces (the first to third surfaces 341 to 343) of the positive electrode tab 340. In this case, the first to third solder layers 701 to 703 may completely cover the outer surfaces of the positive electrode tab 340, e.g., the first surface 341, the second surface 342, and the third surfaces 343 of the positive electrode tab 340.

In one embodiment, solder layers may be selectively formed on the outer surfaces of the positive electrode tab 340 by attaching blocking tape to regions of the positive electrode tab 340 that are not soldered. A solder layer 630 may be additionally formed on a surface of the first terminal 610 to which the positive electrode tab 340 will be soldered.

The negative electrode tab 350 includes a first surface 351 facing the second terminal 620 and a second surface 352 opposite the first surface 351. The first surface 351 and the second surface 352 are connected to each other through third surfaces 353. Unlike the positive electrode tab 340, solder layers are not formed on the negative electrode tab 350.

However, a solder layer 640 may be formed on a surface of the second terminal 620 to which the negative electrode tab 350 will be soldered. For example, in the case of the negative electrode tab 350, soldering may be performed by forming a solder layer on only the first surface 351 of the negative electrode tab 350 or a surface of the second terminal 620. In one embodiment, an electrical path for the negative electrode tab 350 may be formed by forming a solder layer on only the first surface 351 of the negative electrode tab 350 without forming a solder layer on a surface of the second terminal 620.

Thereafter, the first solder layer 701 of the positive electrode tab 340 is soldered to the solder layer 630 of the first terminal 610, and the first surface 351 of the negative electrode tab 350 is soldered to the solder layer 640 of the second terminal 620.

In this case, the total amount of the solder layers 701 to 703 and 630 formed in a joint region between the positive electrode tab 340 and the first terminal 610 may be equal to the total amount of the solder layer 640 formed in a joint region between the negative electrode tab 350 and the second terminal 620.

Referring to FIG. 5A, the secondary battery 300 is attached to the roller 510, for example, using a jig 520 (operation 910 in FIG. 9). The secondary battery 300 includes the positive electrode tab 340 and the negative electrode tab 350. The roller 510 may be rotated in one direction.

Referring to FIG. 5B, preparation is made to insert the secondary battery 300 into the ultrasonic bath 361. The preparation includes rotating the roller 510 to a first position (operation 920 in FIG. 9). At this position, the negative electrode tab 350 is bent from a first position to a second position, e.g., a position different from the positive electrode tab (operation 930 in FIG. 9).

Referring to FIG. 5C, roller 510 is then rotated to align and immerse the positive electrode tab 340 of the secondary battery 300 with the ultrasonic bath 361 (operation 940 in FIG. 9). As a result, solder layers are formed on only the positive electrode tab 340 of the secondary battery 300. However, no solder layer is formed on the negative electrode tab 350 because the negative electrode tab 350 is in the bent position, e.g., before dipping into the ultrasonic bath 361, the negative electrode tab 350 is bent in one direction so that the negative electrode tab 350 may not be dipped into the ultrasonic bath 361. If the positive electrode tab 340 and the negative electrode tab 350 are simultaneously dipped into the ultrasonic bath 361, a short circuit may be formed.

While the positive electrode tab 340 stays in the ultrasonic bath 361, solder layers 701 to 703 (refer to FIG. 7A) are formed on the outer surfaces of the positive electrode tab 340. When the positive electrode tab 340 is dipped into the ultrasonic bath 361, ultrasonic waves may be generated from the ultrasonic horn 362 (refer to FIG. 3) disposed on a side of the ultrasonic bath 361 so as to form the solder layers 701 to 703 (refer to FIG. 7A) on the outer surfaces (refer to reference numerals 341 to 343 in FIG. 7A) of the positive electrode tab 340.

At this time, soldering may be performed under the following conditions: a solder solution including tin (Sn), silver (Ag), and copper (Cu) is filled in the ultrasonic bath 361, a dipping period is about 1 second to 3 seconds, and the temperature of the ultrasonic bath 361 is about 300° C.

Before the solder layers 701 to 703 (refer to FIG. 7A) are formed on the outer surfaces 341 to 343 (refer to FIG. 7A) of the positive electrode tab 340, as shown in FIGS. 4A and 4B, an oxide layer 340b may be partially removed from the positive electrode tab plate 340a by ultrasonic vibration. Then, solder layers may be formed on surfaces 340c from which the oxide layer 340b is removed.

Referring to FIG. 5D, after the solder layers 701 to 703 are formed on the positive electrode tab 340, the roller 510 is rotated to remove the positive electrode tab 340 from the ultrasonic bath 361 (operation 950 in FIG. 9). Thereafter, the bent negative electrode tab 350 is bent again to its original position (operation 960 in FIG. 9).

As shown in FIG. 6A, the circuit board 600 includes the first terminal 610 and the second terminal 620. Referring to FIG. 6B, solder layers 630 and 640 are formed on the first terminal 610 and the second terminal 620. The solder layers 630 and 640 may be formed on the first and second terminals 610 and 620 through a reflow process.

Next, as shown in FIG. 7A, the positive electrode tab 340 and the negative electrode tab 350 are aligned with the first terminal 610 and the second terminal 620 (operation 970 in FIG. 9).

The first solder layer 701, the second solder layer 702, and the third solder layers 703 are respectively formed on the first surface 341 of the positive electrode tab 340 facing the first terminal 610, the second surface 342 opposite to the first surface 341, and the third surfaces 343 connecting the first and second surfaces 341 and 342. The first to third solder layers 701 to 703 may be formed through an ultrasonic soldering process.

The solder layer 630 may be formed on a surface of the first terminal 610 to which the positive electrode tab 340 will be soldered. However, no solder layer is formed on the negative electrode tab 350. The solder layer 640 may be formed on a surface of the second terminal 620 to which the negative electrode tab 350 will be soldered.

Next, the positive electrode tab 340 and the negative electrode tab 350 are respectively soldered to the first terminal 610 and the second terminal 620 using a joining unit (operation 980 in FIG. 9). In one embodiment, the joining unit includes first and second pressing members 710 and 720.

For example, as shown in FIG. 7B, the positive electrode tab 340 and the negative electrode tab 350 are brought into contact with the first terminal 610 and the second terminal 620, respectively. Next, the first pressing member 710 is placed above a contact between the positive electrode tab 340 and the first terminal 610, and the second pressing member 720 is placed above a contact between the negative electrode tab 350 and the second terminal 620.

For example, the first and second pressing members 710 and 720 may be placed above the contacts to push the positive electrode tab 340 and the negative electrode tab 350 against the first and second terminals 610 and 620. The first and second pressing members 710 and 720 include cylindrical pipes. The first and second pressing members 710 and 720 may be coupled to a jig for simultaneously pressing the positive electrode tab 340 and the negative electrode tab 350.

In one embodiment, the first and second pressing members 710 and 720 may be elastic biasing members. The first and second pressing members 710 and 720 are not limited as long as the first and second pressing members 710 and 720 are able to press portions to be soldered.

In a pressed state, laser beams are emitted through holes of the first and second pressing members 710 and 720 so as to solder the positive electrode tab 340 and the negative electrode tab 350 to the first terminal 610 and the second terminal 620.

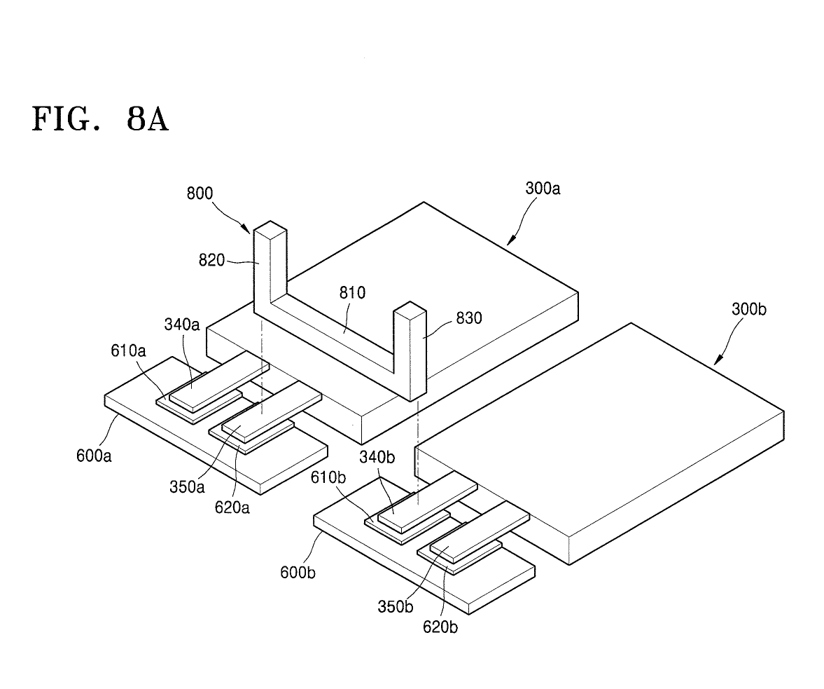

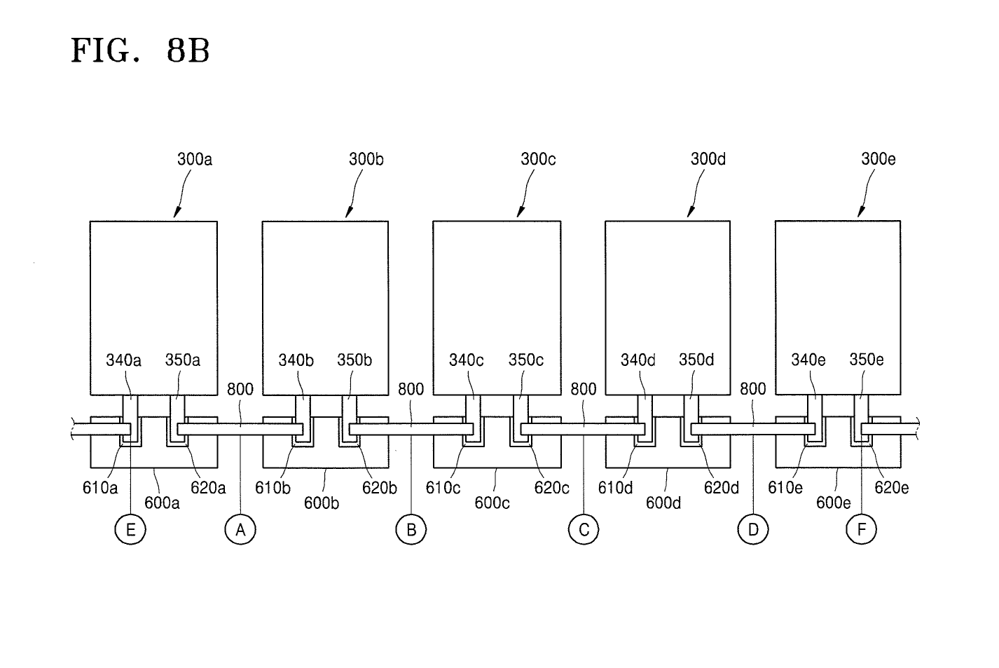

In another embodiment, the joining unit includes a hot bar 800. For example, referring to FIG. 8A, a first secondary battery 300a and a second secondary battery 300b are arranged side by side. The first secondary battery 300a includes a first positive electrode tab 340a and a first negative electrode tab 350a, and the second secondary battery 300b includes a second positive electrode tab 340b and a second negative electrode tab 350b.

The first positive electrode tab 340a and the first negative electrode tab 350a may be respectively soldered to a first terminal 610a and a second terminal 620a of a first circuit board 600a, and the second positive electrode tab 340b and the second negative electrode tab 350b may be respectively soldered to a first terminal 610b and a second terminal 620b of a second circuit board 600b.

Neighboring negative and positive electrode tabs having different polarities of the first secondary battery 300a and the second secondary battery 300b may be simultaneously pressed by the hot bar 800. For example, the hot bar 800 may simultaneously press a contact portion between the first negative electrode tab 350a of the first secondary battery 300a and the second terminal 620a of the first circuit board 600a and a contact portion between the second positive electrode tab 340b of the second secondary battery 300b and the first terminal 610b of the second circuit board 600b.

The hot bar 800 includes a horizontal frame 810, a first vertical frame 820 vertically extending from a side of the horizontal frame 810, and a second vertical frame 830 extending vertically from the other side of the horizontal frame 810. For example, a portion around the first vertical frame 820 may press the contact portion between the first negative electrode tab 350a of the first secondary battery 300a and the second terminal 620a of the first circuit board 600a, and a portion around the second vertical frame 830 may press the contact portion between the second positive electrode tab 340b of the second secondary battery 300b and the first terminal 610b of the second circuit board 600b.

As described above, electrode tabs having different polarities of neighboring secondary batteries 300a and 300b are simultaneously pressed because a short circuit may be formed if positive and negative electrode tabs of the same secondary battery are simultaneously pressed.

FIG. 8B illustrates an embodiment of a soldering process for the case in which five secondary batteries 300a to 300e are arranged like in FIG. 8A. Referring to FIG. 8B, a first secondary battery 300a, a second secondary battery 300b, a third secondary battery 300c, a fourth secondary battery 300d, and a fifth secondary battery 300e are sequentially arranged.

The first to fifth secondary batteries 300a to 300e include first to fifth positive electrode tabs 340a to 340e and first to fifth negative electrode tabs 350a to 350e. The first to fifth positive electrode tabs 340a to 340e may be respectively soldered to first terminals 610a to 610e of first to fifth circuit boards 600a to 600e. The first to fifth negative electrode tabs 350a to 350e may be respectively soldered to second terminals 620a to 620e of the first to fifth circuit boards 600a to 600e.

In this case, each pair having different polarities of the positive electrode tabs 340a to 340e and the negative electrode tabs 350a to 350e of the neighboring first to fifth secondary batteries 300a to 300e may be simultaneously pressed by a hot bar 800. A soldering process may be performed while sequentially moving a single hot bar 800. In one embodiment, a plurality of hot bars 800 may be used as illustrated in FIG. 8B.

For example, the hot bar 800 is placed on the first negative electrode tab 350a of the first secondary battery 300a and the second positive electrode tab 340b of the second secondary battery 300b that neighbor each other, and a first soldering operation A is performed while applying heat and pressure.

Next, the hot bar 800 is placed on the second negative electrode tab 350b of the second secondary battery 300b and the third positive electrode tab 340c of the third secondary battery 300c that neighbor each other, and a second soldering operation B is performed while applying heat and pressure.

Next, the hot bar 800 is placed on the third negative electrode tab 350c of the third secondary battery 300c and the fourth positive electrode tab 340d of the fourth secondary battery 300d that neighbor each other, and a third soldering operation C is performed while applying heat and pressure.

Next, the hot bar 800 is placed on the fourth negative electrode tab 350d of the fourth secondary battery 300d and the fifth positive electrode tab 340e of the fifth secondary battery 300e that neighbor each other, and a fourth soldering operation D is performed while applying heat and pressure.

Next, the hot bar 800 is placed on the first positive electrode tab 340a of the first secondary battery 300a, and a fifth soldering operation E is performed while applying heat and pressure.

Then, the hot bar 800 is placed on the fifth negative electrode tab 350e of the fifth secondary battery 300e, and a sixth soldering operation F is performed while applying heat and pressure.

In this way, the five secondary batteries 300a to 300e may be soldered by performing a hot pressing operation six times using the hot bar 800.

In accordance with one or more of the aforementioned embodiments, electrode tabs of secondary batteries having different polarities may easily be electrically connected to terminals of protective circuit boards. In one embodiment, a solder layer is applied to a positive electrode tab and no solder layer is applied to the negative electrode tab. In another embodiment, a solder layer may be applied to the negative electrode tab and no solder layer may be applied to the positive electrode tab depending, for example, on the materials used for the electrode tabs.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the present invention as set forth in the following claims.

What is claimed is:

1. A secondary battery, comprising:
a bare cell including an electrode assembly, electrode tabs, and a case accommodating the electrode assembly, the electrode assembly including a separator between a positive electrode plate and a negative electrode plate, the electrode tabs including positive and negative electrode tabs respectively extending from the positive and negative electrode plates; and
a protective circuit module outside the case and including a protective circuit board, a first terminal, and a second terminal, the first and second terminals on the protective circuit board and electrically connected to the positive and negative electrode tabs, respectively, wherein:
the positive electrode tab and the negative electrode tab are respectively soldered to the first terminal and the second terminal,
solder layers are on respective surfaces of the positive electrode tab soldered to the first terminal, and
a solder layer is on one or more of the second terminal or the negative electrode tab.

2. The secondary battery as claimed in claim 1, wherein:
the positive electrode tab includes a first surface facing the first terminal and a second surface opposite the first surface, and
a first solder layer is on the first surface and a second solder layer is on the second surface.

3. The secondary battery as claimed in claim 2, wherein:
the positive electrode tab includes a third surface connecting the first and second surfaces, and
a third solder layer is on the third surface.

4. The secondary battery as claimed in claim 2, wherein a solder layer is on a surface of the first terminal facing the first surface of the positive electrode tab.

5. The secondary battery as claimed in claim 1, wherein the solder layers are held on the positive electrode tab by ultrasonic solder.

6. The secondary battery as claimed in claim 1, wherein:
the negative electrode tab includes a first surface facing the second terminal and a second surface opposite the first surface, and
the solder layer is on one or more of the first surface of the negative electrode tab or a surface of the second terminal facing the first surface of the negative electrode tab.

7. The secondary battery as claimed in claim 6, wherein the solder layer is on only the surface of the second terminal.

8. The secondary battery as claimed in claim 1, wherein at least a surface portion of the positive electrode tab excludes an oxide layer.

9. A method for forming a secondary battery, comprising:
applying a solder layer to a first electrode tab of the battery;
aligning the first electrode tab and a second electrode tab of the battery with respective first and second terminals; and
applying heat to solder the first and second electrode tabs to the first and second terminals, respectively, wherein the first electrode tab includes a first metal and the second electrode tab includes a second metal different from the first metal, and wherein the second electrode tab excludes a solder layer before heat when the first and second electrode tabs are aligned with the first and second terminals.

10. The method as claimed in claim 9, wherein:
the first electrode tab is a positive electrode tab, and
the second electrode tab is a negative electrode tab.

11. The method as claimed in claim 9, wherein:
the first electrode tab includes aluminum, and
the second electrode tab includes nickel.

12. The method as claimed in claim 9, further comprising:
applying a solder layer to the second terminal before the heat is applied.

13. The method as claimed in claim 9, wherein applying the solder layer to the first electrode tab includes:
bending the second electrode tab from a first position to a second position;
exposing the first electrode tab to an ultrasonic bath without exposing the second electrode tab to the ultrasonic bath, exposure to the ultrasonic bath forming the solder layer on the first electrode tab; and
bending the second electrode tab from the second position to the first position.

14. The method as claimed in claim 13, wherein the first electrode tab is in the first position when exposed to the ultrasonic bath.

15. The method as claimed in claim 9, wherein applying heat includes:
applying heat to solder the first and second electrode tabs to the first and second terminals, respectively, at substantially a same time.

16. The method as claimed in claim 9, wherein applying heat includes:
applying heat to the first electrode tab and an electrode tab of a first different battery at substantially a same time, and
applying heat to the second electrode tab an electrode tab of a second different battery at substantially a same time.

17. The method as claimed in claim 16, wherein:
the heat is applied to the first electrode tab and the electrode tab of the first different battery at a first time,
the heat is applied to the second electrode tab and the electrode tab of the second different battery at a second time, and
the first time is different from the second time.

18. The method as claimed in claim 9, wherein the first electrode tab excludes a surface oxide layer.

19. An electrode tab arrangement for a secondary battery, comprising:
a first electrode tab;
a second electrode tab;
a first terminal attached to the first electrode tab; and
a second terminal attached to the second electrode tab, wherein the first electrode tab includes a solder layer at a first time when the first terminal is soldered to the first electrode tab, and wherein the second electrode tab excludes a solder layer at a second time when the second terminal is soldered to the second electrode tab.

20. The electrode tab arrangement as claimed in claim 19, wherein the first time is equal to the second time.
